(19) United States
(12) Patent Application Publication
(10) Pub. No.: US 2014/0198629 A1
(43) Pub. Date: Jul. 17, 2014

(54) STORAGE DEVICE AND STORAGE METHOD

(71) Applicants: Yuji Takagi, Osaka (JP); Yoshihisa Takahashi, Osaka (JP); Makoto Usui, Osaka (JP)

(72) Inventors: Yuji Takagi, Osaka (JP); Yoshihisa Takahashi, Osaka (JP); Makoto Usui, Osaka (JP)

(73) Assignee: PANASONIC CORPORATION, Osaka (JP)

(21) Appl. No.: 14/127,956

(22) PCT Filed: Jul. 3, 2012
(86) PCT No.: PCT/JP2012/004298

§ 371 Date: Dec. 19, 2013

(30) Foreign Application Priority Data
Jul. 6, 2011 (JP) 2011-149819

(51) Int. Cl. G11B 7/0045; G11B 7/005

(52) U.S. Cl. CPC G11B 7/0045; G11B 7/005
USPC 369/100

(57) ABSTRACT

A storage device 101 in one aspect of the present invention records/reproduces data to/from a plurality of exchangeable recording media 105 using a plurality of drive units 111. The plurality of recording media are stored in magazines 104, and are attached/detached to/from the storage device in a magazine-by-magazine manner. The storage device includes a transport section 108 for transporting a plurality of recording media between the magazine attached to the storage device and the plurality of drive units, and a RAID control section 103 for dividing data depending on a predetermined RAID to be formed by a plurality of recording media and recording in parallel the data to the plurality of recording media using two or more of the drive units, wherein one RAID is formed by one magazine.

### TECHNICAL FIELD

The present application relates to a device and a method for storing data, and relates to a disc array device in which a RAID system is formed using a plurality of exchangeable recording media, such as optical discs, for example.

### BACKGROUND ART

In computer systems such as commercial servers, disc array devices have been used as external storage devices for realizing a large capacity and improvements in the transfer rate and the fault tolerance.

With a disc array device, fault tolerance (high reliability) and a high transfer rate are realized by forming a RAID (Redundant Arrays of Inexpensive Disks) which adds parallel processing and redundancy using a plurality of drive units.

Commonly-used RAID configurations include, for example, a RAID1 for mirroring, a RAID5 for recording, in a distributed manner, a parity calculated for each block, a RAID6 for recording, in a distributed manner, two different parities calculated for each block. Other schemes are also used where these RAID configurations are combined together.

With conventional disc array devices, it is common to use hard disk drives as drive units in view of the per-unit recording capacity and the performance.

On the other hand, in recent years, the capacity of data to be stored has been increasing dramatically. With a disc array device using hard disk drive devices, it is inevitable to add drive devices in order to increase the capacity, thereby resulting in an increase in the amount of energy consumption.

Therefore, there is a demand for disc array devices with smaller amounts of energy consumption. One such disc array device with smaller amounts of energy consumption is disc array devices using optical discs (e.g., Patent Documents 1 and 2).

### CITATION LIST

### Patent Literature

[Patent Document No. 1] Japanese Laid-Open Patent Publication No. 8-249794

[Patent Document No. 2] Japanese Laid-Open Patent Publication No. 2000-122812

### SUMMARY OF INVENTION

### Technical Problem

With a disc array device using exchangeable recording media such as optical discs, however, when the recording media are taken out from the disc array device and stored, the order of the recording media may be altered or recording media may get mixed in another group, thus presenting a problem that it is not easy to manage recording media. A non-limiting example embodiment of the present invention provides a storage device and a storage method, with which recording media can be managed more easily when they are stored.

### Solution to Problem

A storage device in one aspect of the present invention is a storage device for recording/reproducing data to/from a plurality of exchangeable recording media using a plurality of drive units, wherein: the plurality of recording media are stored in magazines, and are attached/detached to/from the storage device in a magazine-by-magazine manner, the storage device including: a transport section for transporting the plurality of recording media between the magazine attached to the storage device and the plurality of drive units; and a RAID control section for dividing data depending on a predetermined RAID to be formed by a plurality of recording media and recording in parallel the data to the plurality of recording media using two or more of the drive units, wherein one RAID is formed by one magazine.

### Advantageous Effects of Invention

With the storage device in one aspect of the present invention, when a RAID is formed using a plurality of exchangeable recording media, the plurality of recording media can be easily managed and stored as a group in a centralized manner even after they are taken out from a changer system or an array device.

### BRIEF DESCRIPTION OF DRAWINGS

FIG. 1 A block diagram showing a configuration of a disc array device according to an example embodiment.

FIG. 2 A diagram illustrating an operation of the disc array device of the example embodiment.

FIG. 3 A diagram illustrating an operation where a magazine containing six recording media therein is attached to the disc array device of the example embodiment.

FIG. 4 A diagram illustrating an operation where a magazine containing five recording media therein is attached to the disc array device of the example embodiment.

FIG. 5 A diagram illustrating an operation where a magazine containing four recording media therein is attached to the disc array device of the example embodiment.

FIG. 6 A flow chart showing an operation of the disc array device of the example embodiment.

FIG. 7 A block diagram showing a configuration of a disc array device according to an example embodiment.

FIG. 8 A block diagram showing a configuration of a disc array device according to an example embodiment.

FIG. 9 A block diagram showing a configuration of an optical disc array device.

### DESCRIPTION OF EMBODIMENTS

The present invention is based on the following findings.

FIG. 9 shows an example of an optical disc array device forming a RAID using optical discs. In the optical disc array device shown in FIG. 9 connected to a host computer, a plurality of optical discs 805 to 808 are inserted into a plurality of optical disc drives 801 to 804, and data are recorded in a distributed manner across the plurality of optical discs, thus forming a RAID. A RAID control section 809 performs a RAID control for dividing data into a plurality of pieces, and recording/reproducing in parallel the data to/from the plurality of drive units.

FIG. 9 shows an example where a recording operation is performed in a RAID5. Data sent from the host computer is divided into three pieces (e.g., A1, B1 and C1) each being a block of a predetermined size, and a parity block (e.g., P1) for the divided three blocks, thereby forming a RAID with a total of four blocks. The parity block stores the result of exclusive OR between data points from the blocks A1, B1, C1 at the same byte position.

The divided data blocks and the parity block thereof are recorded/reproduced in parallel to/from the four optical discs 805 to 808 by means of the four optical disc drives 801 to 804. In a RAID5, the parity blocks are recorded while being distributed across four discs (e.g., A2, B2, P2, C2) by switching the optical disc to record a parity block from one to another for each of the four blocks so as to prevent parity blocks from being recorded on a single disc in a localized manner.

Moreover, FIG. 9 shows an optical disc array device, showing an example of a changer system configuration in which a large number of optical discs are stored in a container 810 of the changer. Reference numeral 811 denotes an optical disc taken out from the container. With an array device using exchangeable recording media, it is possible to apparently infinitely increase the recording capacity with no energy consumption by taking out a recorded optical disc from the array device to store the recorded optical disc off-line and inserting a new optical disc into the container.

Where a RAID is formed and divided pieces of data are recorded/reproduced to/from a plurality of recording media, the order or the grouping of the plurality of recording media need to be managed as a group in a centralized manner. If there is a flaw in the order or the grouping of the recording media in each group, it is no longer possible to normally record/reproduce the data. Moreover, data can no longer be normally recorded/reproduced if a wrong RAID configuration is employed, e.g., when reproducing in a RAID6 data that have been recorded in a RAID5.

In the optical disc array device shown in FIG. 9, the four optical discs 805 to 808 make up one group, forming a RAID5. In the present specification, a such group of recording media will be referred to as a RAID group.

The container 810 normally has some tens to about 100 optical discs stored therein, and the disc capacity that can be used on-line is increased by switching these optical discs from one to another by means of a changer. Thus, the container 810 has optical discs stored therein, with many RAID groups co-existing therein. Many RAID groups also co-exist in the optical disc 811 taken out from the container 810.

Where a RAID is formed and divided pieces of data are recorded/reproduced to/from a plurality of recording media, the order or the grouping of the recording media need to be managed as a group in a centralized manner. If there is a flaw in the order or the grouping of the recording media, it is no longer possible to normally record/reproduce the data. On the other hand, with exchangeable recording media, the degree of freedom is high for combinations between drive units and recording media to be placed therein. Therefore, where a RAID is formed using exchangeable recording media, it is not easy to manage groups of recording media after they are taken out from the optical disc array device. For example, when storing many recording media taken out from the optical disc array device, the order of recording media may be altered within the same group or a recording medium of another group may get mixed in. Similarly, when a recording medium which has been stored is set in the optical disc array device, the order of the recording media may be altered or a recording medium of another group may get mixed in.

The optical disc changer device disclosed in Patent Document No. 1 has the same problem as that described above. With the optical disc changer device disclosed in Patent Document No. 1, optical discs classified into groups are transferred by groups from the storage section inside the optical disc changer device to a drive device to be recorded/reproduced, and are stored again in the storage section by groups. With this optical disc changer device, however, there is no consideration as to how to manage groups of optical discs after they are taken out from the optical disc changer device. Therefore, when archiving only recording media, it is not easy to manage groups of recording media.

According to Patent Document No. 2, a removable recording medium is assigned unique identification information, and the validity of the grouping of recording media is judged based on identification information of recording media mounted on a storage device, wherein if there is found a flaw in the validity, one or more of the recording media mounted on the storage device are returned to the container, thereby preventing data from being recorded/reproduced to/from a wrong RAID group. With this method, however, a flow in a RAID group is not prevented from occurring in the first place, but a flaw in the validity of the group is detected after recording media are once mounted on the drive device, thereby requiring an excessive amount of process time for the checking.

In one aspect of the present invention, there is provided a disc array device capable of easily managing in a centralized manner and storing recording media in such a manner that a flaw is less likely to occur in the RAID group even after they are taken out from the disc array device.

An outline of one aspect of the present invention is as follows.

A storage device in one aspect of the present invention is a storage device for recording/reproducing data to/from a plurality of exchangeable recording media using a plurality of drive units, wherein: the plurality of recording media are stored in magazines, and are attached/detached to/from the storage device in a magazine-by-magazine manner, the storage device including: a transport section for transporting the plurality of recording media between the magazine attached to the storage device and the plurality of drive units; and a RAID control section for dividing data depending on a predetermined RAID to be formed by a plurality of recording media and recording in parallel the data to the plurality of recording media using two or more of the drive units, wherein one RAID is formed by one magazine.

For example, the one RAID is formed by all the recording media stored in the one magazine.

For example, the storage device further includes: a detection section for detecting the number of the recording media stored in the magazine, wherein the RAID control section switches a type of RAID from one to another depending on the detected number of recording media.

For example, the RAID control section switches the type of RAID from one to another depending on the detected number of recording media and a reliability required.

A plurality of the magazines are attached/detached to/from the storage device; and where the number of recording media stored in at least one of the plurality of magazines is different from another magazine, the RAID control section switches the type of RAID from one to another so that a data transfer rate is constant for any of the plurality of magazines attached.

For example, a maximum of six recording media can be stored in the magazine; and the RAID control section forms a RAID1 when the detected number of recording media is six, a RAID6 when the detected number is five, and a RAID5 when the detected number is four.

For example, the storage device further includes: a container for simultaneously storing a plurality of the magazines, wherein: the storage device switches a magazine to be used between the plurality of magazines; and the plurality of magazines are attached/detached to/from the storage device in a magazine-by-magazine manner.

For example, the plurality of recording media are, for each magazine, either all write-once-type optical discs or all rewritable-type optical discs.

For example, the storage device further includes at least one spare drive unit, which is used as a spare when at least one of the plurality of drive units fails.

For example, the magazine is provided with information indicating the number of recording media stored therein; and the detection section detects the number of recording media from the information indicating the number of recording media.

The detection section detects the number of recording media by detecting recording media transported from the magazine.

A storage method in one aspect of the present invention is a storage method for recording/reproducing data to/from a plurality of exchangeable recording media using a plurality of drive units, wherein: the plurality of recording media are stored in magazines, and are attached/detached to/from a storage device in a magazine-by-magazine manner; the storage device includes the plurality of drive units; and the storage method includes: a step of transporting the plurality of recording media between the magazine attached to the storage device and the plurality of drive units; and a step of dividing data depending on a predetermined RAID to be formed by a plurality of recording media and recording in parallel the data to the plurality of recording media using two or more of the drive units, wherein one RAID is formed by one magazine.

A magazine in one aspect of the present invention is a magazine for storing a plurality of recording media therein, wherein attachment/detachment thereof to/from a storage device is done in a magazine-by-magazine manner, the storage device including: a plurality of drive units for recording/reproducing data to/from the plurality of recording media; a transport section for transporting the plurality of recording media between the magazine attached to the storage device and the plurality of drive units; and a RAID control section for dividing data depending on a predetermined RAID to be formed by a plurality of recording media and recording in parallel the data to the plurality of recording media using two or more of the drive units, wherein one RAID is formed by one magazine.

Embodiments of the present invention will now be described with reference to the drawings.

### Embodiment 1

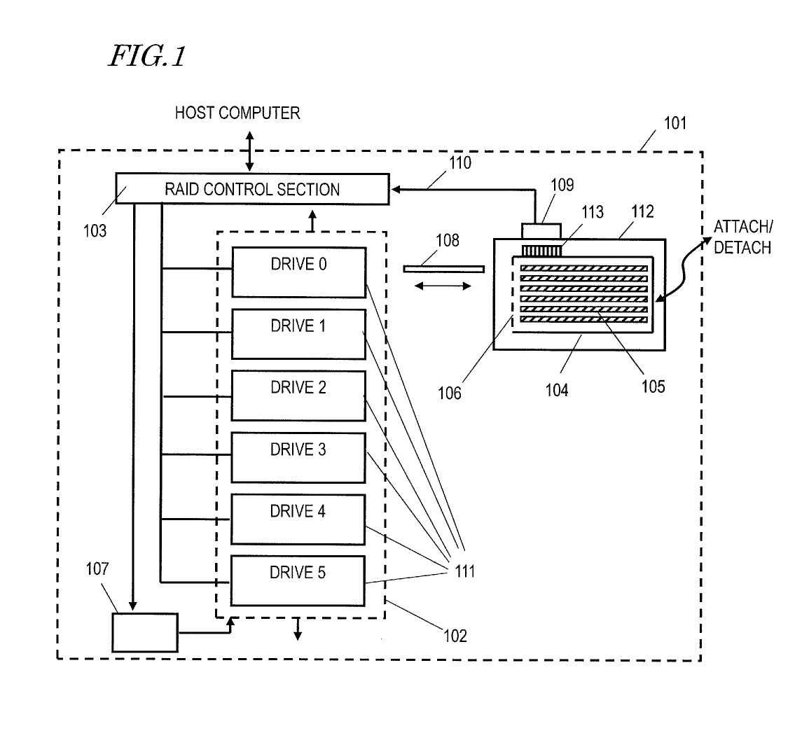

FIG. 1 is a block diagram showing a configuration of a disc array device 101 according to Embodiment 1 of the present invention. The disc array device 101 is a storage device for recording/reproducing data to/from a plurality of exchangeable recording media using a plurality of drive units.

In FIG. 1, a RAID control section 103 is a controller which forms a RAID by controlling six optical disc drive units 111 (Drive 0 to Drive 5). The RAID control section 103 is formed by a microprocessor, a memory, software, and the like. The optical disc drive unit 111 is a device for reproducing and recording data from/to an optical disc placed therein. A magazine 104 is capable of storing a plurality of optical discs 105 therein, and is capable of storing a maximum of six discs in this example. With the disc array device 101 of Embodiment 1, the number of drive units is equal to the number of optical discs that can be stored in a magazine.

FIG. 1 shows a state where the magazine 104 having six optical discs 105 stored therein is attached to the disc array device 101. The magazine 104 is attached to and detached from a magazine receiving section 112 of the disc array device 101, and the attaching/detaching is done in a magazine-by-magazine manner. A shutter 106 is provided on the front side of the magazine 104 so that the stored optical discs cannot easily be taken out from the magazine 104 when it has been detached from the disc array device 101. Note that although the shutter 106 is herein described as being a shutter, it may be any other configuration as long as the stored optical discs cannot easily be taken out.

The magazine 104 is also provided with a switch 113 for indicating the number of discs stored therein, and the number of discs is read by a detection section 109 provided in the magazine receiving section 112. Herein, it is detected that six optical discs are stored. The switch 113 and the detection section 109 may be formed by, for example, a tab-shaped slide switch or a sensor hole and a detector for use therewith. Alternatively, the magazine may be provided with an RF tag, wherein the RF tag stores identification information for identifying the magazine itself or management information such as the number of discs stored in the magazine, which can be detected.

Note that it is assumed herein that the detection of the number of discs is done by means of the switch 113 and the detection section 109, but the number of discs may be detected by any other method. For example, it may be detected as the number of discs that have been transported in the disc transportation process as will be described below. Alternatively, after transporting a disc, each optical disc drive unit 111 may detect whether or not the disc has been inserted. Alternatively, a plurality of different magazines having different thicknesses may be provided, for example, so as to mechanically detect the thickness.

Transport sections 107 and 108 insert the optical discs 105 stored in the magazine 104 respectively into the optical disc drive units 111 (Drive 0 to Drive 5). The transport section 107 moves the entire collection of optical disc drive units 111 as a single group of drive units 102 in the vertical direction, and the transport section 108 takes out each optical disc 105 from the magazine 104 at a time to move the optical disc 105 in the horizontal direction so as to insert the optical discs 105 one-by-one into the optical disc drive units 111. The vertical and horizontal movements of the transport sections 107 and 108 are controlled by the RAID control section 103.

Also when returning the optical discs 105 in the optical disc drive units 111 into the magazine 104, it is done by the RAID control section 103 controlling the vertical and horizontal movements of the transport sections 107 and 108, so that the optical discs 105 are returned into the magazine 104 as they were therein originally (including the order thereof). Note that the magazine 104 may be moved in the vertical direction, instead of moving the group of drive units 102 in the vertical direction.

When the magazine 104 is attached to the disc array device 101 of Embodiment 1 having such a configuration as described above, the switch 113 provided on the magazine 104 is read by the detection section 109, thereby reading the number of discs. The read number-of-discs information 110 is sent to the RAID control section 103.

According to the number-of-discs information 110 detected by the detector 109, the RAID control section 103 controls the movement of the transport sections 107 and 108 in the vertical direction and in the horizontal direction, and takes out the optical discs 105 one-by-one from the magazine 104 and inserts the optical discs 105 one-by-one into the optical disc drive units 111.

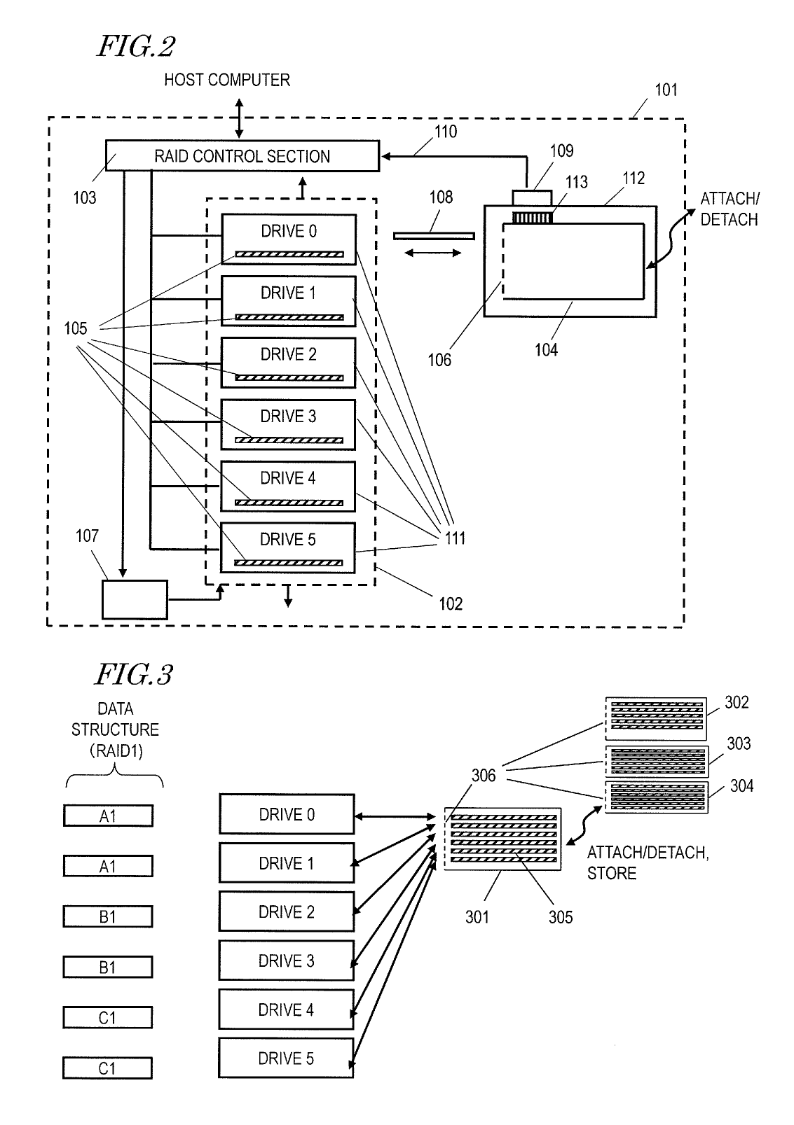

FIG. 2 shows a state where the optical discs 105 have been taken out from the magazine 104 and inserted one-by-one into the optical disc drive units 111.

In FIG. 2, one optical disc 105 is inserted into each optical disc drive unit 111, and the magazine 104, from which discs have been taken out, is empty.

The RAID control section 103 forms a predetermined RAID group depending on the number-of-discs information 110 detected by the detector 109, and the optical disc drive units 111 are controlled accordingly, thereby recording/reproducing data in parallel in a distributed manner across a plurality of optical discs. A RAID1 is formed when the number of optical discs is six, a RAID6 when it is five, and a RAID5 when it is four. By forming a RAID for recording/reproducing data to/from a plurality of optical discs 105 by adding parallel processing and redundancy using a plurality of optical disc drive units 111, it is possible to realize a very high reliability and a high transfer rate as compared with a case where one optical disc is recorded/reproduced using a single optical disc drive.

When detaching the magazine 104 from the disc array device 101, the optical discs 105 inserted into the optical disc drive units 111 are returned into the magazine 104 prior to the detachment. Returning of the discs into the magazine 104 is done as the RAID control section 103 controls the vertical and horizontal movements of the transport sections 107 and 108. After the optical discs 105 are returned into the magazine 104 as they were therein originally (including the order thereof), the magazine 104 is detached from the disc array device 101.

With the optical disc array device 101 of Embodiment 1, a predetermined RAID group is formed only by a plurality of optical discs stored in one magazine, as described above, and the discs are taken out from the disc array device in a magazine-by-magazine manner. Moreover, it is configured so that stored optical discs cannot easily be taken out from a magazine when it has been detached from the disc array device 101. As a result, where a magazine detached from the disc array device is kept in a shelf, or the like, for example, to be stored off-line over a long period of time, the configuration physically prevents the occurrence of a flaw in the RAID group due to some optical discs missing or alteration of the order of optical discs; therefore, it is possible to easily manage and store, in a magazine-by-magazine manner and in a centralized manner, a plurality of recording media forming a RAID.

FIG. 3 is a diagram illustrating the details of an operation where a magazine having six optical discs therein is attached to the disc array device 101 of Embodiment 1 of the present invention described above.

In FIG. 3, six optical discs 305 are stored in a magazine 301. The optical discs 305 are inserted one-by-one into six optical disc drives (Drive 0 to Drive 5). The RAID control section 103 divides data into three blocks A1, B1 and C1 and duplicates each block, to record the data blocks in parallel by means of the six optical disc drives. This is a RAID1 configuration, which simultaneously realizes distribution (striping) and duplication (mirroring) of data. Note that it is assumed herein that RAID1 includes RAID1+0 (RAID10) and RAID0+1 (RAID01), where striping and mirroring are realized simultaneously.

The formation of a RAID1 with six optical discs as described above realizes a transfer rate three times as high as that when recording on one optical disc and a high reliability. Since RAID1 with mirroring is used herein, the reliability is highest as compared with RAID6 or RAID5 to be described below.

With the disc array device 101 of Embodiment 1, a predetermined RAID group is formed by a plurality of optical discs 305 stored in one magazine 301, and the attaching/detaching to/from the disc array device 101 is done in a magazine-by-magazine manner. Conversely speaking, each magazine, which is the unit of attachment/detachment, forms a RAID group.

In FIG. 3, magazines 302, 303 and 304 denote other magazines which have been detached from the disc array device 101, each magazine forming a RAID group. Each magazine is provided with a shutter 306 so that optical discs stored therein cannot easily be taken out from the magazine when it has been detached from the disc array device 101. This prevents the occurrence of a flaw in the RAID group due to some optical discs missing or alteration of the order of optical discs forming the RAID. Moreover, since the configuration of the RAID group is determined based on the number of optical discs stored in the magazine, the RAID configuration cannot possibly be mistaken for a wrong RAID configuration.

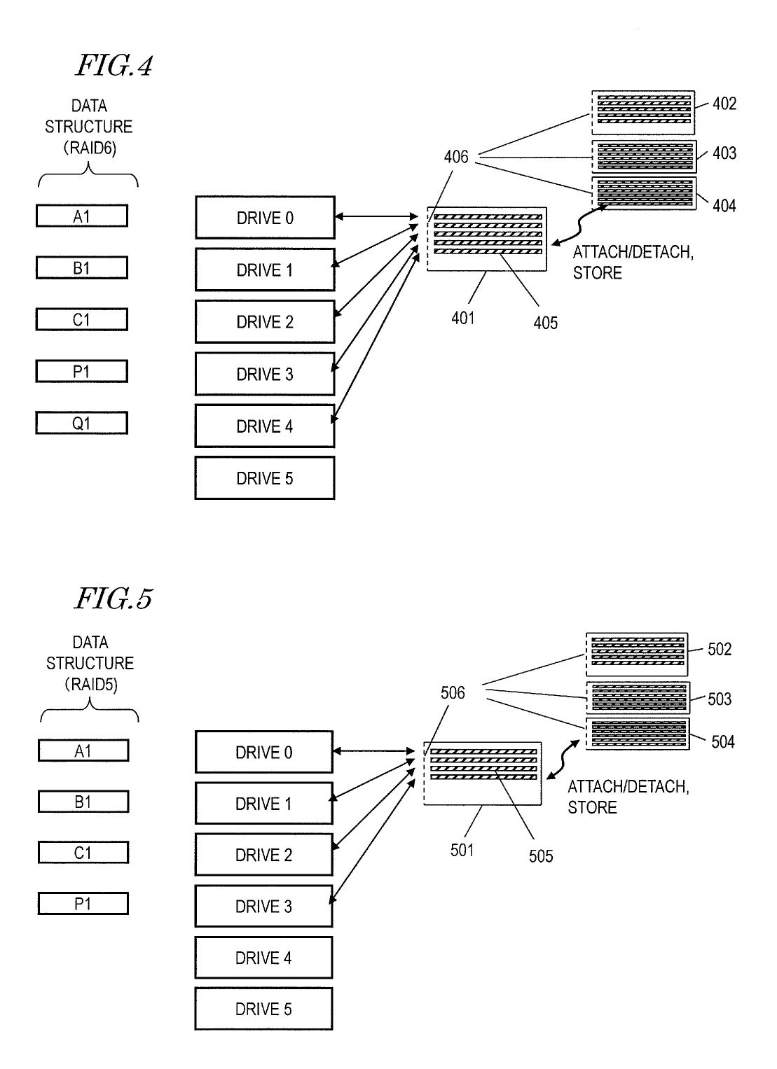

FIG. 4 is a diagram illustrating an operation where a magazine containing five optical discs therein is attached to the disc array device 101 of Embodiment 1 of the present invention.

In FIG. 4, five optical discs 405 are stored in a magazine 401. The optical discs 405 are inserted one-by-one into five optical disc drives (Drive 0 to Drive 4). The RAID control section 103 divides data into three blocks A1, B1 and C1. It further generates two parity blocks P1 and Q1 therefor, and records these blocks in parallel by means of the five optical disc drives. A RAID6 configuration is employed herein where striped data and two parities are recorded in parallel.

The formation of a RAID6 with five optical discs as described above realizes a transfer rate three times as high as that when recording on one optical disc and a high reliability. Since a RAID6 configuration is used herein, the reliability is higher as compared with that of a RAID5 to be described below. Although the reliability is lower than that of the RAID1 configuration illustrated in FIG. 3, the number of discs is smaller accordingly, thereby allowing for a cost reduction.

With the disc array device 101 of Embodiment 1 of the present invention, a predetermined RAID group is formed by a plurality of optical discs 405 stored in one magazine 401, and the attaching/detaching to/from the disc array device 101 is done in a magazine-by-magazine manner. Conversely speaking, each magazine, which is the unit of attachment/detachment, forms a RAID group.

In FIG. 4, magazines 402, 403 and 404 denote other magazines which have been detached from the disc array device 101, each magazine forming a RAID group. Each magazine is provided with a shutter 406 so that optical discs stored therein cannot easily be taken out from the magazine when it has been detached from the disc array device 101, thereby preventing the occurrence of a flaw in the RAID group due to some optical discs missing or alteration of the order of optical discs forming the RAID. Moreover, since the configuration of the RAID group is determined based on the number of optical discs stored in the magazine, the configuration has a high reliability and is prevented from recording/reproducing data with a wrong RAID configuration.

FIG. 5 is a diagram illustrating an operation where a magazine containing four optical discs therein is attached to the disc array device 101 of Embodiment 1 of the present invention.

In FIG. 5, four optical discs 505 are stored in a magazine 501. The optical discs 505 are inserted one-by-one into four optical disc drives (Drive 0 to Drive 3). The RAID control section 103 divides data into three blocks A1, B1 and C1. It further generates a parity block 21 therefor, and records these blocks in parallel by means of the four optical disc drives. A RAID5 configuration is employed herein where striped data and a parity are recorded in parallel.

The formation of a RAID5 with four optical discs as described above realizes a transfer rate three times as high as that when recording on one optical disc and a high reliability. Since a RAID5 configuration is used herein, the reliability is lower as compared with those of a RAID1 or a RAID6 described above, but the number of discs is smallest accordingly, thereby achieving the lowest cost.

With the disc array device 101 of Embodiment 1 of the present invention, a predetermined RAID group is formed by a plurality of optical discs 505 stored in one magazine 501, and the attaching/detaching to/from the disc array device 101 is done in a magazine-by-magazine manner. Conversely speaking, each magazine, which is the unit of attachment/detachment, forms a RAID group.

In FIG. 5, magazines 502, 503 and 504 denote other magazines which have been detached from the disc array device 101, each magazine forming a RAID group. Each magazine is provided with a shutter 506 so that optical discs stored therein cannot easily be taken out from the magazine when it has been detached from the disc array device 101, thereby preventing the occurrence of a flaw in the RAID group due to some optical discs missing or alteration of the order of optical discs forming the RAID. Moreover, since the configuration of the RAID group is determined based on the number of optical discs stored in the magazine, the configuration is prevented from recording/reproducing data with a wrong RAID configuration.

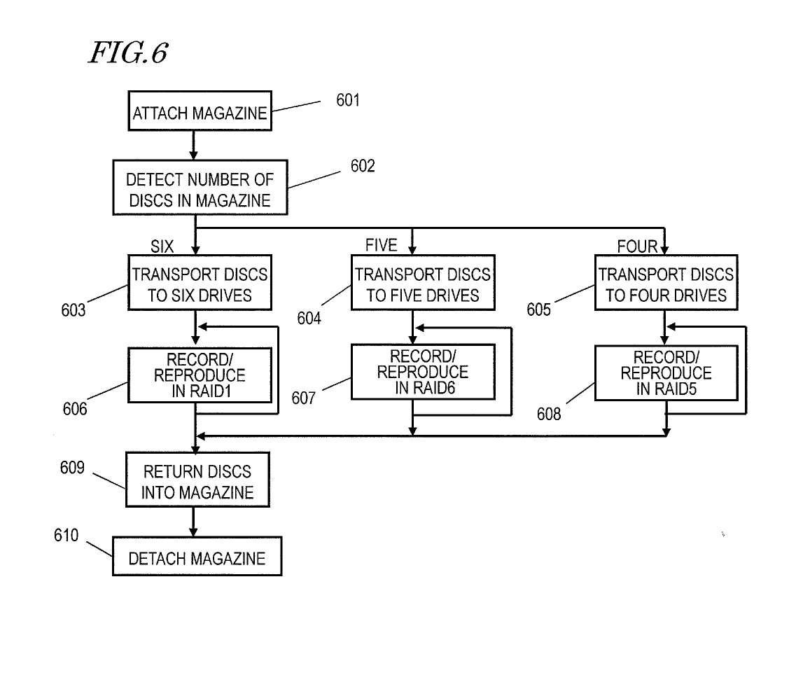

FIG. 6 is a flow chart showing an operation of the disc array device 101 of Embodiment 1.

In step 601, the magazine 104 having a predetermined number of optical discs stored therein is attached to the disc array device 101.

In step 602, the number of discs in the magazine is read by the detection section 109 provided in the magazine receiving section 112.

In step 603, 604, 605, the discs are transported to the optical disc drive units 111.

In step 606, 607, 608, a predetermined RAID configuration is formed based on the number of discs, and data are recorded/reproduced. A RAID1 group is formed when the number of discs is six, a RAID6 group when it is five, and a RAID5 group when it is four. Thereafter, until the magazine is detached, data are recorded/reproduced in parallel in a predetermined RAID configuration.

When detaching the magazine, the RAID control section 103 controls the vertical and horizontal movements of the transport sections 107 and 108 in step 609, thereby returning the optical discs 105 into the magazine 104 as they were therein originally (including the order thereof).

In step 610, the magazine 104 is detached from the disc array device 101.

As described above, with the disc array device of Embodiment 1, data are recorded/reproduced while a predetermined RAID group is formed by each magazine, which is the unit of attachment/detachment; therefore, even after recording media are taken out from the array device, the plurality of recording media can be easily managed and stored as a group in a centralized manner. Since the optical discs stored in a magazine cannot easily be taken out from the magazine when it has been detached from the device, thereby physically preventing the occurrence of a flaw in the RAID group due to some optical discs missing or alteration of the order of optical discs forming the RAID.

Moreover, since the RAID group configuration is determined based on the number of optical discs stored in the magazine, the configuration has a high reliability and is prevented from recording/reproducing data with a wrong RAID configuration; therefore, even after recording media are taken out from the disc array device, the plurality of recording media can be easily stored and managed as a group over a long period of time, simply by storing the magazine in a shelf, or the like, for example.

Since the RAID group configuration is switched between a RAID1, a RAID6 and a RAID5 depending on the number of optical discs stored in the magazine, each magazine will have the same recording capacity and data transfer rate, making it possible to easily change only the reliability depending on the cost. As a result, by selecting a magazine to be used depending on the reliability required for the data and the cost prior to the use of the magazine, it is possible to realize a storage of which the reliability can easily be selected by the user, which is easy to handle, and with which data can be managed easily.

Note that one of possible RAID configurations using all optical discs stored in a single magazine that has the highest reliability may be formed, or another RAID configuration may be formed depending on the reliability required, as long as one RAID is formed by one magazine.

As to the type of optical discs to be stored in magazines, the optical discs may be, for each magazine, either all write-once-type optical discs or all rewritable-type optical discs. As recording media of the same type are stored in each magazine, the user can easily select a magazine depending on the application.

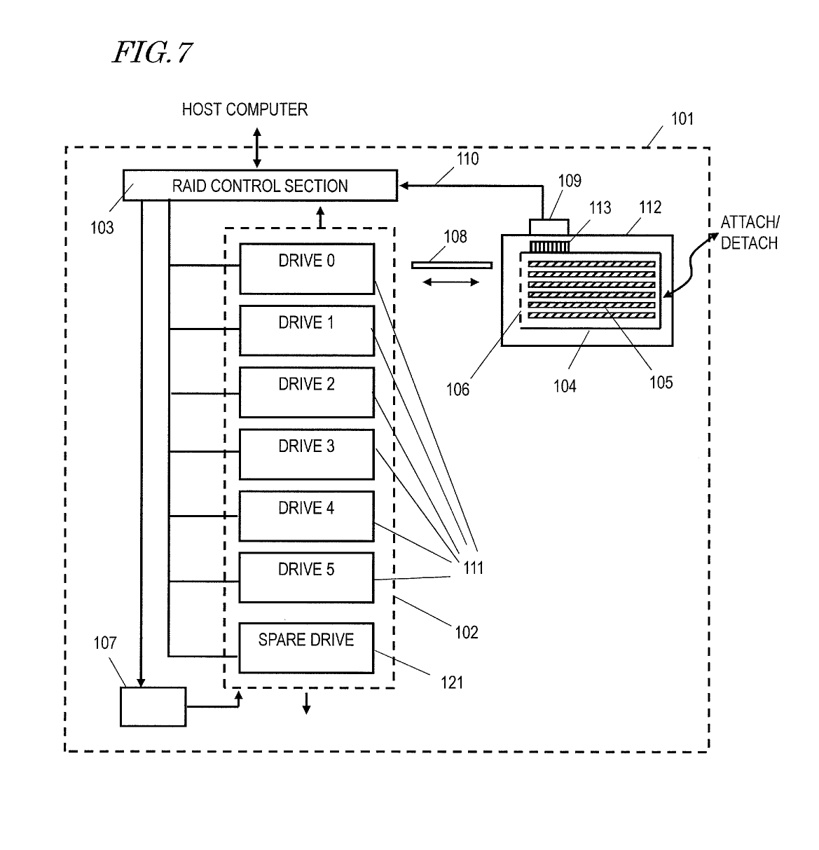

As shown in FIG. 7, the disc array device 101 may include one or more spare drive unit 121, which can be used as a spare when one drive unit 111 fails. By providing at least one spare drive unit 121, data can be continuously recorded/reproduced even when one drive unit 111 fails, thus realizing a disc array device with a stable operation.

### Embodiment 2

A disc array device 700 according to Embodiment 2 of the present invention is different from the disc array device 101 of Embodiment 1 in that a plurality of magazines can be attached thereto at the same time, and the magazine to be used is selected by a changer. With the disc array device 700 of Embodiment 2, as in Embodiment 1, the number of drive units is equal to the number of optical discs that can be stored in one magazine. They are both six herein.

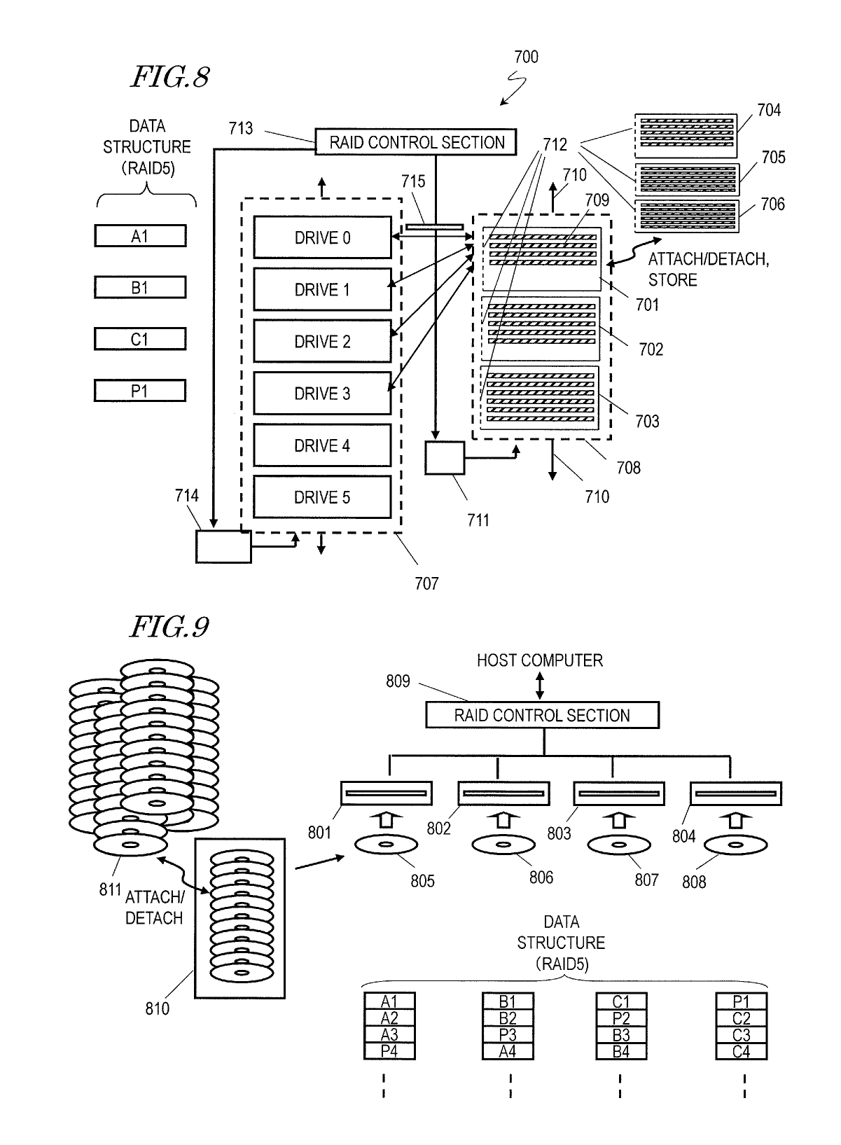

FIG. 8 is a block diagram illustrating a configuration of a disc array device according to Embodiment 2 of the present invention.

In FIG. 8, a plurality of magazines 701, 702 and 703 are attached to a magazine container 708. The disc array device of Embodiment 2 has a changer configuration capable of switching between a plurality of magazines stored in the container 708 to select a magazine to be used. The magazine switching is done through vertical movements 710 of the entire container 708 by means of a magazine transport section 711, and the selection of a magazine to be used is made dependent on the height position of the magazine. In FIG. 8, it is indicated that the magazine 701 is to be used as the height position of the magazine 701 is at the height position of a magazine to be used.

The magazine 701 has four optical discs 709 stored therein. As in Embodiment 1, a RAID control section 713 uses a transport section 714 to control the vertical movement of a group of drive units 707 as a whole, and uses a transport section 715 for taking out and inserting optical discs in the horizontal direction, so that the optical discs 709 stored in the magazine 701 are inserted one-by-one into four optical disc drive units (Drive 0 to Drive 3).

The RAID control section 713 divides data into three blocks A1, B1 and C1. It further generates a parity block P1 therefor, and records these blocks in parallel by means of the four optical disc drives. A RAID5 configuration is employed herein where striped data and a parity are recorded in parallel by means of a plurality of drives.

The formation of a RAID5 with four optical discs as described above realizes a transfer rate three times as high as that when recording on one optical disc and a high reliability. Since a RAID5 configuration is used herein, the reliability is lower as compared with those of a RAID1 or a RAID6 described above in Embodiment 1, but the number of discs is smallest accordingly, thereby achieving the lowest cost.

When switching to another magazine to be used, the optical discs 709 inserted in the optical disc drive units are first returned into the magazine 701 prior to switching the magazine. Returning of the discs into the magazine 701 is done as the RAID control section 713 controls the vertical and horizontal movements of the transport sections 714 and 715.

Next, when the magazine 702 is to be used, for example, the entire container 708 storing magazines therein is moved up by one magazine. The vertical movement of the container 708 is controlled as the RAID control section 713 controls the container transport section 711.

Also in Embodiment 2, as in Embodiment 1, data are recorded/reproduced while changing the RAID configuration depending on the number of optical discs stored in the magazine. Data are recorded/reproduced using a RAID6 for the magazine 702 storing five optical discs therein, and a RAID1 for the magazine 703 storing six optical discs therein. By forming a RAID for recording/reproducing data to/from a plurality of optical discs by adding parallel processing and redundancy using a plurality of optical disc drive units, it is possible to realize a very high reliability and a transfer rate that is several times higher as compared with a case where one optical disc is recorded/reproduced using a single optical disc drive. Note that the switch, the detector, and the like, for detecting the number of optical discs stored in the magazine are omitted in FIG. 8 because they are generally the same as those of Embodiment 1.

In FIG. 8, magazines 704, 705 and 706 denote other magazines which have been detached from the disc array device 700, each magazine forming a RAID group. Each magazine is provided with a shutter 712 so that optical discs stored therein cannot easily be taken out from the magazine when it has been detached from the disc array device, thereby preventing the occurrence of a flaw in the RAID group due to some optical discs missing or alteration of the order of optical discs forming a RAID; therefore, it is possible to easily manage and store, in a magazine-by-magazine manner and in a centralized manner, a plurality of recording media forming a RAID.

Moreover, since the configuration of the RAID group is determined based on the number of optical discs stored in the magazine, the configuration has a high reliability and is prevented from recording/reproducing data with a wrong RAID configuration; therefore, even after recording media are taken out from the disc array device, the plurality of recording media can be easily stored and managed as a group in a centralized manner.

While a plurality of magazines are stored in the container 708 with the disc array device 700 according to Embodiment 2 of the present invention, a predetermined RAID group is formed only by a plurality of optical discs stored in a magazine. No RAID group is formed across a plurality of magazines. Thus, when detaching magazines from the container 708 of the disc array device, it is not necessary to detach some or all magazines simultaneously, but magazines can be detached one-by-one from the disc array device, each magazine being the smallest unit forming a RAID group.

In a RAID system having a changer configuration capable of receiving a plurality of exchangeable media, it is a very useful feature that the taken-out recording media can be easily managed without causing a flaw thereto and that the unit by which they are taken out is small. For example, data that are used frequently may be left, in a magazine-by-magazine manner, in the container of the disc array device, and only those magazines containing data that are used infrequently may be detached from the device to be kept in a shelf, or the like. This allows for an optimal combination between off-line storage in a shelf, or the like, and an on-line storage in the container, providing a configuration where magazines with data used more frequently recorded therein can be always stored on-line.

As described above, the disc array device and the disc array control method of Embodiments 1 and 2 have the following configuration, for example.

That is, the disc array device of Embodiments 1 and 2 is a disc array device for recording/reproducing data using a plurality of drive units to/from a plurality of exchangeable recording media. Herein, recording media stored in magazines each accommodating a maximum of n discs are attached/detached to/from the disc array device in a magazine-by-magazine manner. The disc array device includes: n or more drive units; a transport section for transporting a plurality of recording media between the magazine attached thereto and a plurality of drive units; and a RAID control section for dividing data into blocks of a predetermined RAID group and recording/reproducing the blocks in parallel by means of a plurality of drive units. A plurality of recording media stored in one magazine form a predetermined RAID group.

The disc array control method of Embodiments 1 and 2 is a disc array control method for recording/reproducing data to/from a plurality of exchangeable recording media using a plurality of drive units. The disc array control method includes: a step of attaching/detaching, in a magazine-by-magazine manner, recording media stored in magazines each accommodating a maximum of n discs; a step of transporting a plurality of recording media between the magazine attached thereto and a plurality of drive units; and a RAID control step of dividing data into blocks of a predetermined RAID group and recording/reproducing the blocks in parallel by means of a plurality of drive units. A plurality of recording media stored in one magazine form a predetermined RAID group.

With the disc array device or the disc array control method described above, where a RAID is formed using a plurality of exchangeable recording media, even after recording media are taken out from a changer system or an array device, the plurality of recording media can be easily managed and stored as a group in a centralized manner.

The disc array device of Embodiments 1 and 2 may further include a detection section for detecting the number of recording media stored in a magazine. In this case, the RAID control section may switch the configuration of the RAID group from one to another depending on the detected number of recording media.

The disc array control method of Embodiments 1 and 2 may further include a step of detecting the number of recording media stored in a magazine. In this case, the RAID control step may switch the configuration of the RAID group from one to another depending on the detected number of recording media.

With the disc array device or the disc array control method described above, the configuration has a high reliability and is prevented from recording/reproducing data with a wrong RAID configuration. Therefore, even after recording media are taken out from the disc array device, the plurality of recording media can be easily stored and managed as a group over a long period of time, simply by storing the magazine in a shelf, or the like, for example.

Moreover, with the disc array device of Embodiments 1 and 2, the number of recording media stored in a magazine may be detected by means of a switch provided in the magazine. Alternatively, a plurality of drive units may each detect the placement of a recording medium therein, thereby detecting the number of recording media stored in the magazine.

With the disc array device of Embodiments 1 and 2, the RAID control section may switch the configuration of the RAID group from one to another for a higher reliability when the number of recording media stored in the magazine is larger.

With the disc array device of Embodiments 1 and 2, the RAID control section may switch the configuration of the RAID group from one to another so that the recording capacity, excluding the redundancy, and the data transfer rate are constant for all magazines as long as the number of recording media stored in each magazine is within a predetermined range.

With the disc array device of Embodiments 1 and 2, where a maximum of six recording media can be stored in a magazine, the RAID control section may form a RAID1 when the detected number of recording media is six, and a RAID6 when it is five, and a RAID5 when it is four.

With the disc array control method of Embodiments 1 and 2, the RAID control step may switch the configuration of the RAID group from one to another for a higher reliability when the number of recording media stored in the magazine is larger.

With the disc array control method of Embodiments 1 and 2, the RAID control step may switch the configuration of the RAID group from one to another so that the recording capacity, excluding the redundancy, and the data transfer rate are constant for all magazines as long as the number of recording media stored in each magazine is within a predetermined range.

With the disc array control method of Embodiments 1 and 2, where a maximum of six recording media can be stored in a magazine, the RAID control step may form a RAID1 when the detected number of recording media is six, and a RAID6 when it is five, and a RAID5 when it is four.

With the disc array device or the disc array control method described above, it is possible to select a magazine to be used depending on the reliability required for the data and the cost prior to the use of the magazine. Thus, it is possible to realize a storage of which the reliability can easily be selected by the user, which is easy to handle, and with which data can be managed easily.

With the disc array device of Embodiments 1 and 2, the plurality of recording media may be, for each magazine, either all write-once-type optical discs or all rewritable-type optical discs (where data can be recorded/erased repeatedly).

As described above in Embodiment 2, the disc array device may be configured so that a plurality of magazines are attached thereto and the magazines are switched from one to another by means of a changer.

Note that while the number of drive units is equal to the number of optical discs that can be stored in a magazine in Embodiment 1 and Embodiment 2 described above, the disc array device may be provided with a spare drive unit in advance as a spare drive for use as a backup when a drive unit fails. That is, the plurality of drive units of the disc array device may include one or more spare drive unit. In such a case, the number of drive units is larger than the number of optical discs that can be stored in a magazine.

Note that while the RAID configuration to be used is RAID1, RAID6 or RAID5 in Embodiment 1 and Embodiment 2, some of these RAID configurations or other RAID configurations may be combined together. Where a magazine has two optical discs stored therein, for example, a RAID1 (mirroring) may be formed for recording/reproducing data using two drive units.

While the RAID configuration to be used is switched from one to another depending on the number of optical discs stored in the magazine in Embodiment 1 and Embodiment 2, a predetermined RAID configuration may be used. Alternatively, the magazine may be provided with an RF tag, or the like, wherein the RAID configuration to be used is specified by the RF tag.

While optical discs are used as an example of recording media in the above description, the present invention is not limited to optical discs. For example, the recording medium may be a semiconductor memory such as a flash memory, or a magnetic tape. The present invention is applicable to any storage device in which a RAID is formed using a plurality of exchangeable recording media.

While particular embodiments of the present invention have been described above, it is clear to those skilled in the art that the present invention includes many other variations, modifications and applications. Thus, the present invention is not limited to the particular embodiments herein, but can be limited only by the claims.

### INDUSTRIAL APPLICABILITY

According to the present invention, attaching/detaching is done in a magazine-by-magazine manner, each of which has a plurality of exchangeable recording media stored therein, and a plurality of recording media stored in one magazine form a predetermined RAID group. Thus, even after recording media are taken out from a changer system or an array device, the recording media can be easily managed and stored in a centralized manner while preventing the occurrence of a flaw in the RAID group. The present invention is applicable to archiver devices in computer systems, for example.

### Reference Signs List

101 Disc array device
103, 713, 809 RAID control section
104, 301-304, 401-404, 501-504, 701-706 Magazine
105, 305, 405, 505, 709, 805-808 Optical disc
106, 306, 406, 506, 712 Shutter
111 Optical disc drive unit
107, 108, 714, 715 Transport section
708 Container
711 Transport section

1-13. (canceled)

14. A storage device for recording/reproducing data to/from a plurality of exchangeable recording media using a plurality of drive units, wherein:
the plurality of recording media are stored in magazines, and are attached/detached to/from the storage device in a magazine-by-magazine manner, the storage device comprising:
a transport section for transporting the plurality of recording media between the magazine attached to the storage device and the plurality of drive units; and
a RAID control section for dividing data depending on a predetermined RAID to be formed by a plurality of recording media and recording in parallel the data to the plurality of recording media using two or more of the drive units, wherein:
the magazine includes an RF tag storing at least one of magazine identification information for identifying the magazine and management information for managing a RAID to be formed by the recording media in the magazine; and
one RAID is formed by one magazine.

15. The storage device of claim 14, wherein the one RAID is formed by all the recording media stored in the one magazine.

16. The storage device of claim 14, wherein the management information includes at least one of information regarding the number of recording media in the magazine and information regarding a type of RAID to be formed by the recording media in the magazine.

17. The storage device of claim 14, wherein the magazine includes a shutter for preventing the plurality of recording media from being taken out from the magazine when the magazine has been detached from the storage device.

18. The storage device of claim 16, wherein:
a plurality of the magazines are attached/detached to/from the storage device; and
where the number of recording media stored in at least one of the plurality of magazines is different from another magazine, the RAID control section switches the type of RAID from one to another so that a data transfer rate is constant for any of the plurality of magazines attached.

19. The storage device of claim 18, wherein:
a maximum of six recording media can be stored in the magazine; and
the RAID control section forms a RAID1 when the number of recording media is six, a RAID6 when the number is five, and a RAID5 when the number is four.

20. The storage device of claim 14, further comprising:
a container for simultaneously storing a plurality of the magazines, wherein:
the storage device switches a magazine to be used between the plurality of magazines; and
the plurality of magazines are attached/detached to/from the storage device in a magazine-by-magazine manner.

21. The storage device of claim 14, wherein the plurality of recording media are, for each magazine, either all write-once-type optical discs or all rewritable-type optical discs.

22. The storage device of claim 14, further comprising at least one spare drive unit, which is used as a spare when at least one of the plurality of drive units fails.

23. A magazine for storing a plurality of recording media therein, wherein attachment/detachment thereof to/from a storage device is done in a magazine-by-magazine manner, the storage device comprising:
a plurality of drive units for recording/reproducing data to/from the plurality of recording media;
a transport section for transporting the plurality of recording media between the magazine attached to the storage device and the plurality of drive units; and
a RAID control section for dividing data depending on a predetermined RAID to be formed by a plurality of recording media and recording in parallel the data to the plurality of recording media using two or more of the drive units, wherein:
the magazine includes an RF tag storing at least one of magazine identification information for identifying the magazine and management information for managing a RAID to be formed by the recording media in the magazine;
the magazine includes a shutter for preventing the plurality of recording media from being taken out from the magazine when the magazine has been detached from the storage device; and
one RAID is formed by one magazine.
